(19) United States
(12) Patent Application Publication
(10) Pub. No.: US 2009/0144206 A1
(43) Pub. Date: Jun. 4, 2009

(54) SYSTEM FOR PROVIDING LIFETIME INCOME PROTECTION

(75) Inventor: Edward Eng, Toronto (CA)

Correspondence Address: ROPES & GRAY LLP, PATENT DOCKETING 39/41, ONE INTERNATIONAL PLACE, BOSTON, MA, 02110-2624, US

(73) Assignee: John Hancock Life Insurance Company (U.S.A.), Boston, MA (US)

(21) Appl. No.: 12/325,839

(22) Filed: Dec. 1, 2008

Related U.S. Application Data
(60) Provisional application No. 61/005,038, filed on Nov. 30, 2007.

(51) Int. Cl. G06Q 40/00

(52) U.S. Cl. 705/36 R; 705/35

(57) ABSTRACT

The invention relates to a system for managing a investment product that guarantees minimum withdrawal availability during retirement and provides for fee refunds upon termination of an investor's participation in the plan.

### CROSS-REFERENCE TO RELATED APPLICATIONS

This application claims the benefit of U.S. Provisional Application Ser. No. 61/005,038, filed Nov. 30, 2007, the entire contents of which are incorporated herein by reference.

### BACKGROUND OF THE INVENTION

The need for additional secure retirement resources has increased with increasing average life spans. Individuals and families are forced to plan for longer retirements. Financial services companies have attempted to meet this need through the offering of annuity products that include lifetime income provisions that guarantee a regular payment to a purchaser for the entirety of their life, and in some cases, for the entirety of their spouse's life, too. In other products, investors, instead of receiving payments, are allowed to withdrawal up to a predetermined amount of funds from the investment.

Traditionally, purchasers of annuities sacrifice the upside potential of investing in the equity markets to obtain the security of an annuity. More recently, financial services companies have provided variable annuities that provide payments or withdrawal limits based on the performance of investor's assets in individual stocks or funds, exposing the investor both to the potential upside of equity investing and to the potential risks. To hedge against risks, companies have offered guaranteed variable annuities that provide a lower regular payment in exchange for providing a guaranteed minimum payment/withdrawal availability should the market value of the investor's investments fail to support higher payments due to market fluctuations.

Some retirement products have been instituted within employer retirement plans to reduce costs to investors, and to increase employees investment potential by allowing them to contribute pre-tax dollars to a pool of money (referred to herein as a “benefit base”) that will be used to finance a guaranteed minimum withdrawal availability upon retirement. Some employees are reticent to invest in such products due to the risk that their employer may change retirement providers, thereby denying the employee further access to the product. If the employer ceases to offer the product, the employee most likely will not be able to move their participation in the product to the company's new provider. If the employer ceases to offer the product, at best, the employee or retiree might hope to recoup the current market value of their investments in the product.

Such products, however, like many managed investment vehicles, typically charge a fee for participating. These fees are incurred at regular intervals and reduce the market value of the base investment. Thus, even if the employee recoups the market value of the investments upon the employer ceasing to offer participation in the product, the employee would have irrevocably lost the fees paid to the financial services company for managing the funds invested in the product. The risk of this loss provides a disincentive to employees to contribute into what might other wise be an attractive investment vehicle.

Thus, a need exists for an investment product to be offered within a retirement plan that guarantees minimum withdrawal availability and reduces the risk to investors arising from the potential for their employer ceasing to offer the product.

### SUMMARY OF THE INVENTION

Accordingly, in one aspect, the invention relates to a system for managing a investment product that guarantees minimum withdrawal availability during retirement and provides for fee refunds upon termination of an investor's participation in the product.

In one embodiment the system includes an investor database, a trading system, and a computerized account processor. The investor database stores data about various investors' investments in the securities made in a guaranteed withdrawal availability investment product within a qualified retirement plan. The database also stores a history of fees collected from investors for participation in the product. The trading system is in communication with the database and the account processor. The trading system executes trades of securities initiated by investors participating in the product. The account processor calculates minimum withdrawal availabilities for investors post-retirement, and participation fees to be charged to investors pre- and post-retirement. The account processor also calculates a termination amount upon termination of an investors' participation in the product. The termination amount is calculated to be equal to the market value of the investor's investments in the product at termination, and, if the investor participated in the product for less than a predetermined amount of time (e.g., one year, two years, three years, four years, five years, or more), the fees paid by the investor for such participation. In one implementation, regardless of the duration of the investor's participation, the termination amount includes the participation fees paid during the previous predetermined amount of time. In one implementation, the account processor is also configured to receive a transfer of funds from a participant's retirement account, pay the termination amount back into the retirement account, if requested, and/or make withdrawals available to the investor. The account processor may also be configured to receive investment instructions from an investor, directly, or indirectly via the administrator of the investor's retirement account or a user terminal. Such instructions include, for example, investment trading instructions, product termination instructions, and roll-over request instructions.

According to another aspect, the invention relates to a method including carrying out the functionality described above. In still another aspect, the invention relates to a computer readable medium storing instructions for causing a processor to carry out a method that includes carrying out functionality described above. In a further aspect, the invention relates to system including means for carrying out the functionality described above.

### BRIEF DESCRIPTION OF THE DRAWINGS

The system and methods may be better understood from the following illustrative description with reference to the following drawings in which:

FIG. 1 is a block diagram of a system for managing a retirement plan, according to an illustrative embodiment of the invention.

FIG. 2 is a block diagram of a suitable computer architecture for use in the retirement plan system of FIG. 1, according to an illustrative embodiment of the invention.

FIG. 3 is a flow chart of a method of managing a retirement plan, according to an illustrative embodiment of the invention.

FIG. 4 is a flow chart of a method of determining a termination amount due to an investor in response to the investor terminating participation in the retirement plan, according to an illustrative embodiment of the invention.

### CERTAIN ILLUSTRATIVE EMBODIMENTS OF THE INVENTION

To provide an overall understanding of the invention, certain illustrative embodiments will now be described, including apparatus and methods for managing a retirement plan. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

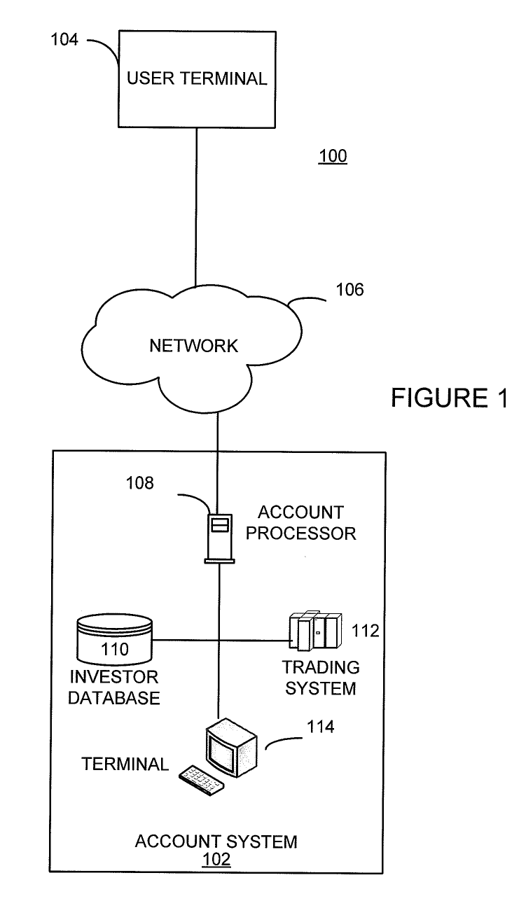

FIG. 1 is a block diagram of a system for managing a retirement plan (referred to herein as the “retirement plan management system 100”). The retirement plan management system 100 includes an account system 102 connected to user client terminals 104 via a network 106. The network 106 may be wired, wireless, or a combination thereof. It may be publicly accessible, such as the Internet, or part of a private communications network. Preferably, at least portions of communications over the networks 106 are encrypted to protect the privacy of plan participants.

The account system 102 is generally responsible for managing the retirement accounts of participants of a qualified retirement plan, for example, a 401(k), or 403(b), or equivalent retirement savings plan. The account system 102 includes an account processor 108, an investor database 110, a trading system 112, and at least one terminal 114. The account system may also include additional conventional network components, such as firewalls, load balancing proxy servers, and other network components known in the art for managing network activity within the account system 102.

In one embodiment, the account processor 108, investor database 110, and trading system 112 constitute separate physical computing devices, such as servers, general purpose processors, or mainframes, or clusters of computing devices. The components of the account system in this implementation are coupled via a local area network 114.

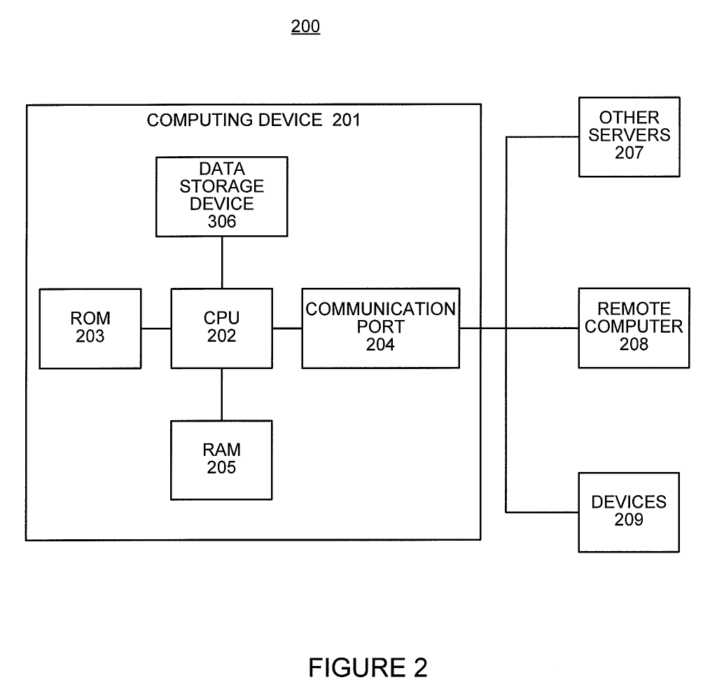

In an alternative implementation, a common processor serves as two or more of the account processor 108, investor database 110, and trading system 112, with separate software modules, when executed on the common processor, causing the common processor to carry out the functionality of the two or more modules. In such cases, the software processes are stored on computer readable media, for loading into memory and execution by a general purpose processor. Additional description about the technical architecture of the above-described components is provided in relation to FIG. 2.

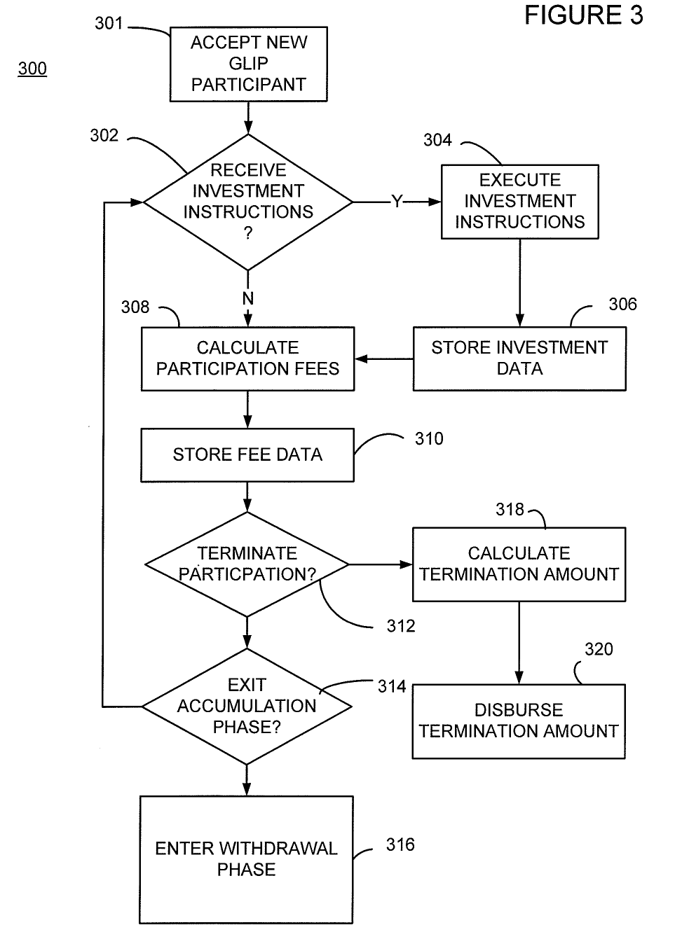

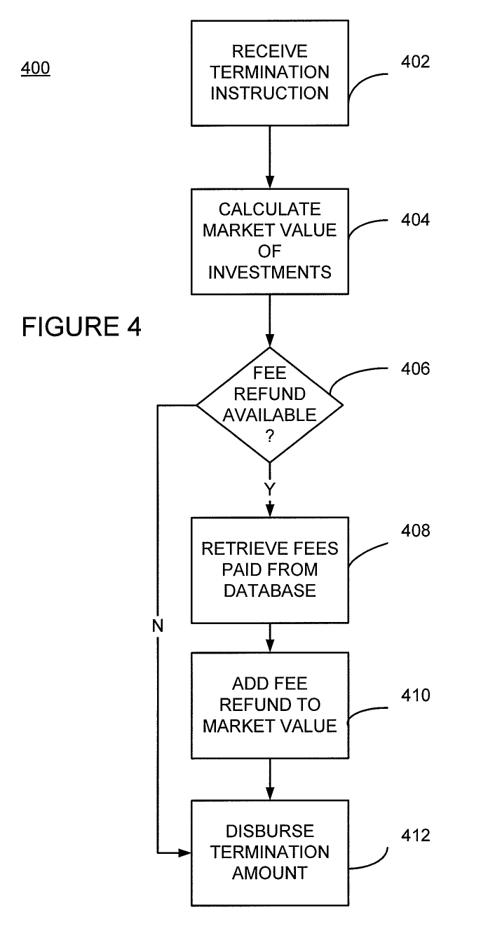

The account processor 108 carries out the primary calculating functions of the account system 100. For example, the account processor 108 is configured to carry out the methods described further in FIGS. 3 and 4. More specifically, the account processor 108 receives investment instructions from plan participants, for example, instructions to enter a guaranteed lifetime income product (“GLIP”), to withdraw from such a product, to trade securities held by the participant, to enter a withdrawal phase, or to obtain disbursements from the product. In addition, the account processor 108 may carry out certain processes automatically on the anniversaries of respective participants joining the GLIP or upon a participant reaching a certain age, as described further below.

In general a guaranteed lifetime income product (“GLIP”) includes two phases, an accumulation phase and a withdrawal phase. During the accumulation phase, a participant invests funds into an account associated with the GLIP to build a pool of funds referred to as a “benefit base”, which will serve as a basis for supporting later guaranteed withdrawal availability during the withdrawal phase. In one implementation, for funds invested in the GLIP, a participant is limited to investing in a limited set of predetermined investment funds, such as mutual funds or exchange traded funds (ETFs). In exchange, in certain embodiments, the participants are guaranteed a minimum benefit base growth, even in times of market contraction. The participant directs his or her investments through a user interface accessible over the network 106 at the user terminal 104, for example in a browser application or dedicated thin or thick client.

At the anniversary of a participant joining the fund, the account processor 108 updates their benefit base to the current market value of their investments in the GLIP. Certain GLIP implementations include a guaranteed minimum benefit base growth rate. In such implementations the account processor 108 updates the benefit base to the larger of the current market value of their investments in the GLIP or the benefit base at the previous anniversary increased by the minimum guaranteed growth rate.

The withdrawal phase begins, typically upon the participant's retirement or at a predetermined age around a typical retirement age (e.g., an age in the range of 55-65). Thus, the account processor 108 can trigger transition to the withdrawal phase automatically upon the participant reaching the predetermined age, or upon receiving an instruction via the user terminal 104. The account processor 108 converts the benefit base to a withdrawal phase benefit base, which serves as basis for the account processor 108 to calculate a guaranteed minimum withdrawal availability. The account processor 108 tracks and updates the withdrawal phase benefit base based on actual levels of participant withdrawals and the performance of the participant's investments. The minimum withdrawal availability is guaranteed in that, as long as the participant does not withdraw more than the guaranteed minimum withdrawal amount, the participant is guaranteed to be able to withdraw the same amount each year for the rest of the participant's life, regardless of market performance. On the other hand, if at the end of a given year the value of the participant's investments less the participant's withdrawals exceeds the prior year's withdrawal phase benefit base, the account processor 108 increases the participants withdrawal phase benefit base accordingly. If during a year, a participant's withdrawals exceed the minimum withdrawal availability, the account processor 108 decreases the withdrawal phase benefit base on a pro rata basis.

When the participant retires, the participant is eligible to withdraw up to a fixed percent of their withdrawal phase benefit base, e.g., between 3% and 7% each year. In some implementations, the participant must have participated in the product for at least a predetermined number of years, e.g., 5 years, before entering the withdrawal phase. The percentage may vary depending on whether the participant elects to have the guaranteed withdrawals extended to the life of his or her spouse (spousal guarantee). If the spousal guarantee is elected, the guaranteed withdrawal availability rate is less than if the guaranteed withdrawal is tied solely to the participant. In one particular example, if the GLIP converts to the withdrawal phase when the participant turns 59½ years old, without a spousal guarantee, the participant will be able to withdraw up to 5% of the value of their benefit base each year for the rest of their life. If they elect the spousal guarantee, the rate is reduced to 4.5%. If the participant in a given year withdraws more than the minimum guaranteed amount, the amount is deducted from the withdrawal phase benefit base in a pro rata basis.

To carry out the calculations and processes described above, the account processor 108 retrieves data from and stores data in the investor database 110 regarding a participant. The investor database 110 stores relevant information about each participant and their respective investments. For a participant currently in the accumulation phase, in one implementation the investor database 110 includes at least the following information: the value of participant's benefit base at the prior anniversary of joining the GLIP, the participant's investments and their respective market values, biographical data about the participant including age and marital status, the number of years the participant has participated in the GLIP, and the fees the participant has paid to participate in the GLIP. Annual fees may range, for example, from about 25 to about 75 basis points of the market value of the participant's investments.

In one implementation of the GLIP and the investor database 110, fee data may be stored separately for each year the participant has participated in the product. In another implementation, the investor database 110 stores the fees the participant has paid in each of a number of predetermined prior years (e.g., the last 3, 4, or 5 years).

The trading system 112 executes the trades input by the participant via the user terminal 104. For example, during the accumulation and withdrawal phases, the user may elect to trade shares in the limited set of funds made available to the them. The trading system 112 is also responsible for selling investor's assets as appropriate to fund withdrawals if needed.

The terminal 114 provides maintenance and management support for the account system 102. For example, plan administrators may use the terminal 114 to alter the set of the funds made available to participants, and/or to alter the fee structure associated with the plan.

FIG. 2 is a block diagram of a computer architecture 200 suitable for implementing various computing devices 201 incorporated into the system 100, including, for example and without limitation, the account processor 108, the investor database 110, the trading system 112, the terminal 112 and the user terminal 104.

Computing device 201 comprises at least one central processing unit (CPU) 202, at least one read-only memory (ROM) 203, at least one communication port or hub 204, at least one random access memory (RAM) 205, and one or more databases or data storage devices 206 (example investor database 110). All of these later elements are in communication with the CPU 202 to facilitate the operation of the computing device 201. The computing device 201 may be configured in many different ways. For example, computing device 201 may be a conventional standalone server computer or alternatively, the function of server may be distributed across multiple computing systems and architectures.

Computing device 201 may be configured in a distributed architecture, wherein databases and processors are housed in separate units or locations. Some such servers perform primary processing functions and contain at a minimum, a general controller or a processor 202, a ROM 203, and a RAM 205. In such an embodiment, each of these servers is attached to a communications hub or port 204 that serves as a primary communication link with other servers 207, client or user computers 208 and other related devices 209. The communications hub or port 204 may have minimal processing capability itself, serving primarily as a communications router. A variety of communications protocols may be part of the system, including but not limited to: Ethernet, SAP, SAS™, ATP, BLUETOOTH™, GSM and TCP/IP.

The CPU 202 comprises a processor, such as one or more conventional microprocessors and one or more supplementary co-processors such as math co-processors. The CPU 202 is in communication with the communication port 204 through which the CPU 202 communicates with other devices such as other servers 207, user terminals 208, or devices 209. The communication port 204 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 202 is also in communication with the data storage device 206. The data storage device 206 may comprise an appropriate combination of magnetic, optical and/or semiconductor memory, and may include, for example, RAM, ROM, flash drive, an optical disc such as a compact disc and/or a hard disk or drive. The CPU 202 and the data storage device 206 each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing. For example, the CPU 202 may be connected to the data storage device 206 via the communication port 204.

The data storage device 206 may store, for example, (i) a program (e.g., computer program code and/or a computer program product) adapted to direct the CPU 202 in accordance with the present invention, and particularly in accordance with the processes described in detail hereinafter with regard to the CPU 202; (ii) databases adapted to store information that may be utilized to store information required by the program. Suitable databases include data warehouse 218 of FIG. 2.

The program may be stored, for example, in a compressed, an uncompiled and/or an encrypted format, and may include computer program code. The instructions of the program may be read into a main memory of the processor from a computer-readable medium other than the data storage device 206, such as from a ROM 203 or from a RAM 205. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as recording product investments, executing product withdrawals, and calculating and updating participant benefit bases. The program also may include program elements such as an operating system, a database management system and “device drivers” that allow the processor to interface with computer peripheral devices (e.g., a video display, a keyboard, a computer mouse, etc.).

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer 208. The remote computer 208 can load the instructions into its dynamic memory and send the instructions over an Ethernet connection, cable line, or even telephone line using a modem. A communications device 204 local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers may also interact and/or control one or more user devices 209, such as displays and printers, or remote computers 208 such as the trading system 112 and investor database 110. These computing devices 201 may include any one or a combination of a mainframe, server, minicomputer, personal computer, a laptop, a personal digital assistant, a mouse, a keyboard, a computer display, a touch screen, LCD, voice recognition software, or other input/output devices required to implement the above functionality.

FIG. 3 is a flow chart of a method 300 of managing a retirement product suitable for use by the account system 102 of FIG. 1, according to an illustrative embodiment of the invention. Referring to FIGS. 1 and 3, the method begins with the account processor 108 accepting a new participant into the GLIP (step 301). If the account processor 108 receives investment instructions at decision block 302, the account processor 108 executes the received investment instructions (step 304) by forwarding the instructions to the trading system 112 and updating the investment database 110 accordingly (step 306). Investment instructions may include, for example, a new contribution to the GLIP, with the contribution being distributed among a predetermined set of funds. The investment instructions may also include an instructions to trade shares of previously purchased funds.

On an annual, monthly, or other suitable periodic basis, the account processor calculates 108 participation fees (step 308) and deducts such fees from the accounts of the participants in the GLIP. As described above, suitable participation fees include fees in the range of about 25 to about 75 basis points of the market value of a participant's investment in the GLIP per year. The account processor 108 stores the fee data in the investor database 110 (step 310).

As long as the investor remains in the product (decision block 312) in the accumulation phase (decision phase 314), the process continues at decision block 302. If, at decision block 314, the investor either reaches a predetermined age or opts to exit the accumulation phase on other grounds, the account processor transitions the participant's account to the withdrawal phase (step 316) as described above. If the participant terminates his participation in the GLIP altogether at decision block 318, the account processor 108 calculates a termination amount (step 318) and disburses it (step 320) to the participant or a participant retirement account. The participant may terminate as a result of the participant's choice, the participant leaving the employer with which the plan is associated, or by the employer deciding to no longer offer the GLIP as part of its retirement benefits, e.g., by switching plan providers.

FIG. 4 is a flow chart of a method 400 for calculating and disbursing a termination fee suitable for use by the account system 102 of FIG. 1, according to an illustrative embodiment of the invention. Referring to FIGS. 1 and 4, The method begins with the account processor 108 receiving a termination instruction (step 402). The termination instruction may be received from the user terminal 104 or from the terminal 114. Next, the account processor calculates the market value of the investments owned by the participant in the product (step 404).

The account processor 108 determines whether a fee refund is available for the participant (decision block 406). In one embodiment, a fee refund is available if the participant has participated in the product for less than a predetermined number of years. Suitable minimum year participation thresholds preferably are less than or equal to 5 years, for example, 3 years, 2 years, or even 1 year. The participant is then due the total fees paid to date, or a portion thereof. In another embodiment, fee refunds are always available. For example, upon termination, the participant is refunded the fees paid over a predetermined number of prior years, for example, the last 5 years, 4 years, 3 years, 2 years, or 1 year, or a fraction thereof. In still other embodiments, the account processor 108 applies additional criteria in determining whether a refund is available. For example, the fee refund may be denied if the performance of the selected funds over a prior predetermined number of years exceeded a performance threshold relative to the market as a whole, represented, for example, by the S&P 500, Russell 2000, or other market index. In another example, fee refunds are not provided if the participant terminates his or her participation by choice or by leaving the employer offering the product.

If the account processor 108 determines that a refund is available, the account processor retrieves the fee history data for the participant from the investor database 110 (step 408). For example, the account processor retrieves the total fees paid over a prior number of years as described above. The account processor 108 then calculates a total termination fee by adding the fee refund value to the market value of the participant's investments (step 410). Finally, the account processor disburses the total termination fee to the participant (step 412). The disbursement can be a direct disbursement or a disbursement into another qualified investment account, for example, the participant's general employee retirement account or a separate traditional, Roth, or other form of IRA.

The availability of a fee refund helps mitigate the risks associated with participating in a GLIP, i.e., the loss of paid fees without incurring the GLIP benefits (e.g., the guaranteed withdrawal availability), thereby encouraging employees to take advantage of an otherwise valuable financial planning tool.

The invention may be embodied in other specific forms without departing from the spirit or essential characteristics thereof. The foregoing embodiments are therefore to be considered in all respects illustrative, rather than limiting of the invention.

What is claimed is:

1. A system for managing a guaranteed withdrawal availability investment product comprising:
an investor database for storing data about investments within a retirement plan and fees collected in relation to managing such investments,
a computerized account processor configured for:
calculating a minimum withdrawal availability for a first participant post-retirement,
calculating participation fees to be charged to a second participant for participating in the product during an accumulation phase, and
calculating a termination amount for second participant upon receiving an indication of the second participant's termination of participation in the product, wherein the termination amount is based on the market value of the second participant's investments in the product and the participation fees charged to the second participant during a previous predetermined amount of time.

2. The system of claim 1, comprising a trading system in communication with the investor database and account processor for executing investment trades requested by the first or second participant.

3. The system of claim 1, wherein the computerized account processor calculates the termination amount to be equal to the sum of the market value of the second participant's investments in the product and the participation fees charged to the second participant during a previous predetermined amount of time.

4. The system of claim 3, wherein the predetermined amount of time is a period ranging from about 1 to about 5 years.

5. The system of claim 3, wherein the predetermined amount of time is the prior three years.

6. The system of claim 1, wherein the investor database stores a benefit base for the first and second participants, and the account processor calculates the minimum withdrawal availability for the first participant based on the stored benefit base.

7. The system of claim 6, wherein the account processor stores an updated benefit base for the first participant in response to an increase in the market value of the investments of first participant.

8. The system of claim 1, wherein the indication of the second participant's termination of participation in the product comprises an indication of an employer of the participant ceasing to offer the product.

9. The system of claim 1, wherein the indication of the employer ceasing to offer the product comprises an indication of the employer changing retirement plan providers.

10. A method of managing a guaranteed withdrawal availability investment product comprising:
storing in an investor database data about investments within a retirement plan and fees collected in relation to managing such investments,
calculating by a computerized account processor a minimum withdrawal availability for a first participant post-retirement;
calculating by the account processor participation fees to be charged to a second participant for participating in the product based on investment data stored in the investor database for the second participant, and
calculating by the account processor a termination amount for the second participant in response to the second participant's termination of participation in the product, wherein the termination amount is based on the market value of the second participant's investments in the product and the participation fees charged to the at least one participant during a previous predetermined amount of time.

11. The method of claim 10, comprising storing in the database by the account processor a benefit base for the first and second participants, wherein the account processor calculates the minimum withdrawal availability based on the stored benefit base.

12. The method of claim 11, comprising calculating and storing by the account processor an updated benefit base for the first participant in response to an increase in the market value of the investments of the first participant.

13. The method of claim 10, wherein the indication of the second participant's termination of participation in the product comprises an indication of an employer of the participant changing retirement plan providers.

14. A computer readable medium storing instructions for causing a processor to carry out a method of managing a guaranteed withdrawal availability investment product, the method comprising
storing by the processor in an investor database data about investments within a retirement plan and fees collected in relation to managing such investments,
calculating by the processor a minimum withdrawal availability for a first participant post-retirement;
calculating by the processor participation fees to be charged to a second participant for participating in the product, and
calculating by the processor a termination amount for the second participant in response to receiving an indication of the second participant's termination of participation in the product, wherein the termination amount is based on the market value of the second participant's investments in the product and the participation fees charged to the second participant during a previous predetermined amount of time.

15. The computer readable medium of claim 14, storing instructions for causing the processor to store in the database a benefit base for the first and second participants, wherein the processor calculates the minimum withdrawal availability based on the stored benefit base.

16. The computer readable medium of claim 15, storing instructions for causing the processor to store an updated benefit base for the second participant in response to an increase in the market value of the investments of the second participant.

17. The computer readable medium of claim 15, wherein the indication of the second participant's termination of participation in the product comprises an indication of an employer of the participant changing retirement plan providers.

18. A system for managing a managing a guaranteed withdrawal availability investment product comprising:
means for storing in an investor database data about investments within a retirement plan and fees collected in relation to managing such investments,
means for calculating by a computerized account processor a minimum withdrawal availability for a first participant post-retirement;
means for calculating by the account processor participation fees to be charged to a second participant for participating in the product based on investment data stored in the investor database for the second participant, and
means for calculating by the account processor a termination amount for the second participant in response to the second participant's termination of participation in the product, wherein the termination amount is based on the market value of the second participant's investments in the product and the participation fees charged to the at least one participant during a previous predetermined amount of time.

19. The system of claim 18, comprising means for storing in the database a benefit base for the first participant, and the means for calculating the minimum withdrawal availability calculates the minimum withdrawal availability based on the stored benefit base.

20. The system of claim 19, comprising means for storing an updated benefit base for the first participant in response to an increase in the market value of the investments of the first participant.

21. The system of claim 18, wherein the indication of the second participant's termination of participation in the product comprises an indication of an employer of the participant changing retirement plan providers.
